(19) United States
(12) Patent Application Publication
(10) Pub. No.: US 2018/0310349 A1
(43) Pub. Date: Oct. 25, 2018

(54) METHOD AND APPARATUS OF CACHING SERVICE DATA IN LTE NETWORKS

(71) Applicant: Samsung Electronics Co., Ltd., Suwon-si, Gyeonggi-do (KR)

(72) Inventors: Jun WANG, Beijing (CN); Lixiang XU, Beijing (CN); Hong WANG, Beijing (CN); Xiaoning MA, Beijing (CN); Xiaowan KE, Beijing (CN)

(21) Appl. No.: 15/557,935

(22) PCT Filed: Mar. 31, 2016
(86) PCT No.: PCT/KR2016/003308

§ 371 Date: Sep. 13, 2017

(30) Foreign Application Priority Data
Mar. 31, 2015 (CN) 201510148430.2

(51) Int. Cl. H04W 76/12; H04L 29/08; H04W 4/18; H04W 28/06; H04L 12/805

(52) U.S. Cl. CPC H04W 76/12; H04L 67/2842; H04L 12/4633; H04W 28/06; H04L 47/365; H04W 4/185

(57) ABSTRACT

Various examples provide a method of caching service data in LTE networks. A base station parses a data request received from a UE to obtain an identification of requested contents, judges whether the requested contents are cached in the base station, sends the contents to the UE in response to a determination that the requested contents are cached in the base station. In response to a determination that the requested contents are not cached in the base station, the base station judges whether the requested contents are cached in an adjacent base station, and obtains the contents from the adjacent base station and returns the contents to the UE in response to a determination that the requested contents are cached in the adjacent base station. In response to a determination that the requested contents are not cached in adjacent base stations, the base station forwards the data request to an SGW, and returns contents obtained from the SGW to the UE. Various examples also provide another method and apparatus of caching service data in an LTE network. According to the examples, data requests of UEs are not necessarily always forwarded to a business server. Instead, requested data is first sought from a cache (in a base station and/or an SGW) which is the closest to the user to reduce transmission load of the LTE network, reduce the time delay in obtaining service data by users, and improve the quality of experience of users.

### TECHNICAL FIELD

The present invention relates to wireless communications, and particularly to a method and an apparatus of caching service data in an LTE networks.

### BACKGROUND ART

Modern mobile communications are tending to provide high speed transmission of multimedia services for users. FIG. 1 is a schematic diagram illustrating a structure of an architecture evolution (SAE) system.

In the system, user equipment (UE) 101 is a terminal device which receives data. Evolved universal terrestrial radio access network (E-UTRAN) 102 is a wireless access network which includes eNodeBs/NodeBs which provide UEs with interfaces for accessing the wireless network. Mobility management entity (MME) 103 manages mobility context, session context and security information of UEs. Serving gateway (SGW) 104 provides user plane capabilities. MME 103 and SGW 104 may reside in the same physical entity. Packet data network (PDN) gateway (PGW) 105 implements capabilities including accounting, lawful interception and so on, and may reside in the same physical entity with SGW 104. Policy and charging rule capabilities (PCRF) 106 provides Quality of Service (QoS) policies and charging rules. Operator service network 107, including at least one business server, provides service data sources for UEs. Serving GPRS support node (SGSN) 108 is a network node device providing routing for data transmission in the Universal Mobile Telecommunications System (UMTS). Home Subscriber Server (HSS) 109 is a home sub system of the UE, and maintains user information including a current location of the UE, the address of the serving node, user security information, packet data context of the UE, and so on.

In conventional LTE networks, the process of a UE requests data includes: after a bearer is established, the UE sends a data request to a base station via an LTE-Uu interface; the base station forwards the data request via an S1-U interface to the SGW which forwards the data request to the PGW through an S5 interface; the PGW forwards the data request to a business service in an IP service network; the business service sends requested content through the reversed logic path thus provides services to the UE.

With the continuing increasing volume of the over the top (OTT) services, LTE networks should not serve as mere bearer networks and data pipes. There is the need as to how to enable LTE networks to serve UEs more intelligently, how to reduce the transport workload of LTE networks, how to reduce the time delay of accessing service contents by users to improve user experience.

### DISCLOSURE OF INVENTION

### Solution to Problem

Various examples of the present disclosure provide a method and an apparatus of caching service data in an LTE network to reduce the transport workload of the LTE network and to reduce the time delay of accessing service contents by users.

Various examples provide a method of caching service data in an LTE networks. The method may include:

parsing, by a base station, a data request received from a UE to obtain an identification of contents requested by the UE;

judging, by the base station, whether the requested contents are cached in the base station by using the identification, sending the requested contents to the UE in response to a determination that the requested contents are cached in the base station.

In an example, the method may also include:

judging whether the requested contents are cached in an adjacent base station in response to a determination that the requested contents are not cached in the base station;

obtaining the requested contents from the adjacent base station in response to a determination that the requested contents are cached in the adjacent base station, and sending contents obtained from the adjacent base station to the UE; forwarding the data request from the UE to the SGW in response to a determination that the requested contents are not cached in the adjacent base station, and sending contents obtained from the SGW to the UE.

The adjacent base station may include: a second base station connected with the base station via an X2 interface.

In an example, the procedure of obtaining the contents from an adjacent base station may include: sending, by the base station, an identification of the contents and information of a GTP tunnel endpoint of the base station to the adjacent base station to establish a GTP tunnel with the adjacent base station, and receiving the contents from the adjacent base station via the GTP tunnel.

In an example, the method may also include:

forwarding, by the base station, the data request of the UE to an SGW in response to a determination that the requested contents are not stored in the base station, and sending contents obtained from the SGW to the UE.

In an example, the method may also include:

reporting, by the base station, accounting information to the SGW, the accounting information may include at least one of: a user identity, a bearer identity, time and the amount of traffic.

In an example, the method may also include: storing, by the base station, a local cache index table which may include: an identification of contents together with a start address and a length of contents corresponding to the identification in a cache, or an identification of contents together with a start address and an end address of the contents corresponding to the identification in the cache;

the procedure of determining by the base station whether there are the requested contents in a local cache according to the identification may include: searching, by the base station, the local cache index table for the identification of the requested contents, determining the requested contents are in the local cache in response to a determination that the identification of the requested contents is found in the local cache index table, or determining the requested contents are not in the local cache in response to a determination that the identification of the requested contents is not found in the local cache index table.

In an example, the method may also include: storing, by the base station, a cache index list of an adjacent base station which may include: an identification of contents and an identification of the adjacent base station:

the procedure of judging by the base station whether the requested contents are cached in the adjacent base station may include: searching, by the base station, the cache index table of the adjacent base station for the identification of the requested contents, determining the requested contents are cached in the adjacent base station in response to a determination that the identification of the requested contents is found in the cache index table of the adjacent base station, or determining the requested contents are not cached in the adjacent base station in response to a determination that the identification of the requested contents is not found in the cache index table of the adjacent base station.

In an example, the method may also include: after obtaining the contents, caching, by the base station, the contents in the base station, adding a record in the local cache index table stored in the base station, and informing the adjacent base station of at least one record added and/or deleted by the base station.

In an example, the method may also include: obtaining, by the base station, information about an update of contents cached in the adjacent base station, and updating the cache index table of the adjacent base station stored in the base station; the information about an update of contents cached in the adjacent base station may include: an identification of newly added contents and an identification of the adjacent base station, and/or an identification of deleted contents and an identification of the adjacent station.

In an example, the identification of the contents is a uniform resource identifier (URI).

Various examples also provide a base station. The base station may include a first module, a second module and a cache module,

the cache module is configured to cache data;

the first module is configured to parse a data request received from a UE to obtain an identification of contents requested by the UE;

the second module is configured to judge whether the requested contents are cached in the cache module by using the identification of the contents, and return the contents to the UE in response to a determination that the requested contents are cached in the cache module.

Various examples also provide a method of caching service data in an LTE network. The method may include:

parsing, by a SGW, a data request of a UE forwarded by a base station to obtain an identification of requested contents;

determining, by the SGW, whether the requested contents are cached in the SGW by using the identification, sending the requested contents to the base station in response to a determination that the requested contents are cached in the SGW.

In an example, the method may also include:

forwarding, by the SGW, the data request to a PGW in response to a determination that the requested contents are not cached in the SGW, and returning contents obtained from the PGW to the base station.

In an example, the method may also include: storing, by the SGW, a local cache index table which may include: an identification of contents together with a start address and a length of the contents in a cache, or an identification of contents together with a start address and an end address of the contents in the cache;

wherein the procedure of judging by the SGW whether the requested contents are cached in the SGW by using the identification may include: searching, by the SGW, the local cache index table for the identification of the requested contents, determining the requested contents are cached in the SGW in response to a determination that the identification of the requested contents is found in the local cache index table, or determining the requested contents are not cached in the SGW in response to a determination that the identification of the requested contents is not found in the local cache index table.

In an example, the method may also include: after obtaining the contents from the PGW, caching, by the SGW, the contents in the local cache, and adding a record of the contents in the local cache index table stored in the SGW.

An SGW provided by various examples may include a third module, a fourth module and a cache module,

the cache module is configured to cache data;

the third module is configured to parse a data request of a UE forwarded by a base station to obtain an identification of requested contents; and

the fourth module is configured to judge whether the requested contents are cached in the cache module by using the identification of the contents, and return the contents to the UE in response to a determination that the requested contents are cached in the cache module.

According to the method and apparatus of caching service data in LTE networks provided by various examples, data requests of users are not always forwarded to a business server. Instead, requested data is first sought in cache of an apparatus (a base station and/or a SGW) that is which is the closest to the user, thereby the workload of the LTE network may be reduced, time delay in obtaining service data by users may be reduced, and quality of experience (QoE) of users may be improved.

### BRIEF DESCRIPTION OF DRAWINGS

FIG. 1 is a schematic diagram illustrating a structure of a conventional SAE system;

FIG. 2 is a flowchart illustrating a process of obtaining service data from a cache of a base station in accordance with an example of the present disclosure;

FIG. 3 is a flowchart illustrating a process of base stations obtaining and updating cached service data and updating a cache index table in accordance with an example of the present disclosure;

FIG. 4 is a flowchart illustrating a process of obtaining and updating service data cached in an SGW and updating a cache index table in the SGW in accordance with an example of the present disclosure;

FIG. 5 is a schematic diagram illustrating modules of a base station in accordance with an example of the present disclosure;

FIG. 6 is a schematic diagram illustrating modules of an SGW in accordance with an example of the present disclosure.

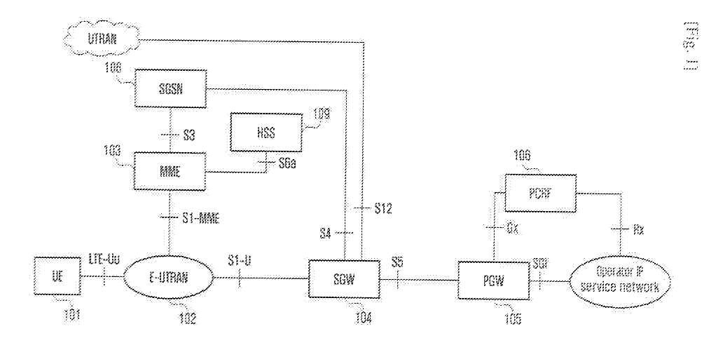

### MODE FOR THE INVENTION

The present invention is hereinafter further described in detail with reference to the accompanying drawings as well as embodiments so as to make the objective, technical solution and merits thereof more apparent.

According to various examples of the present disclosure, service data is cached in an LTE network (including base stations and/or an SGW), and the base stations and/or the SGW are configured to have deep packet inspection (DPI) capabilities. After receiving a data request from a UE, a base station and/or the SGW may parse the data request to obtain an identification of requested contents, and search service data cached in a local cache for the data requested by the UE by using the identification. As such, the UE can obtain data preferentially from the cache in a device which is the closest to the user, thus the workload of the LTE network may be reduced, time delay in obtaining service data by users may be reduced, and QoE of users may be improved.

A method of caching service data in an LTE network provided by various examples may include:

parsing, by a base station, a data request received from a UE to obtain an identification of contents requested by the UE;

judging, by the base station, whether the requested contents are cached in the base station according to the identification, sending the requested contents to the UE in response to a determination that the requested contents are cached in the base station.

When the requested contents are not cached in the base station, various examples provide two processing manners.

According to the first manner,

the base station judges whether the requested contents are cached in an adjacent base station in response to a determination that the requested contents are not cached in the base station;

the base station obtains the requested contents from the adjacent base station in response to a determination that the requested contents are cached in the adjacent base station, and sends contents obtained from the adjacent base station to the UE. In response to a determination that the requested contents are not cached in the adjacent base station, the base station forwards the data request from the UE to an SGW and sends contents obtained from the SGW to the UE.

The adjacent base station may include: a second base station connected with the base station via an X2 interface.

According to the second manner,

the base station forwards the data request of the UE to an SGW in response to a determination that the requested contents are not cached in the base station, and sends contents obtained from the SGW to the UE. According to this manner, the base station may directly request the data from the SGW when the contents requested by the UE are not cached in the base station.

In an example, the base station may store a local cache index table to manage service data cached in the base station. The local cache index table may include: an identification of contents, a start address of the contents in the local cache, and information specifying the size of the contents, e.g., a length of the contents in the cache or an end address of the contents in the cache. The procedure of the base station judging whether the requested contents are cached in the base station may include: the base station searches the local cache index table for the identification of the contents, determining the requested contents are cached in the base station in response to a determination that the identification of the contents is found in the local cache index table, or determining the requested contents are not cached in the base station in response to a determination that the identification of the contents is not found in the local cache index table. In an example, the identification of the contents may be a uniform resource identifier (URI).

In an example, the base station may also store a cache index table of an adjacent base station. The cache index table of the adjacent base station may include: an identification of contents (e.g., a URI) and an identification of the adjacent base station (e.g., eNodeB ID). The procedure of judging whether the requested contents are cached in the adjacent base station may include: the base station searches the cache index table of the adjacent base station stored in the base station for the identification of the requested contents, determining the requested contents are cached in the adjacent base station in response to a determination that the identification of the requested contents is found in the cache index table, or determining the requested contents are not cached in the adjacent base station in response to a determination that the identification of the requested contents is not found in the cache index table.

According to the first manner, the procedure of the base station obtaining the contents from the adjacent base station may include: the base station sends an X2 interface signaling message (e.g., ENB_CONFIGURATION_UPDATE) which includes the identification of the contents and information of a GPRS tunnel protocol (GTP) tunnel endpoint to the adjacent base station to establish a GTP tunnel between the base station and the adjacent base station, and receives the contents from the adjacent base station via the GTP tunnel. The information of the GTP tunnel endpoint may include: a transport layer address and a tunnel ID, or the like.

According to the two manners, the method may also include: after obtaining the contents from the adjacent base station or the SGW, the base station caches the contents in the base station, and updates the local cache index table of the base station, i.e., adding a record of the contents in the local cache index table stored in the base station, and informing the adjacent base station of added records and/or deleted records, e.g., via an ENB_CONFIGURATION_UPDATE. In addition, the base station may encrypt the data using a security algorithm and send the encrypted data to the UE via an LTE-Uu interface when returning the requested contents to the UE.

When service data cached in the base station is subject to a change, the base station may inform adjacent base stations of the change. Alternatively, the base station may periodically inform the adjacent base station of changes in the service data cached in the base station. In an example, the base station may send information about updates in contents cached in the base station to adjacent base stations via ENB_CONFIGURATION_UPDATE, receive ENB_CONFIGURATION_UPDATE from the adjacent base stations to obtain information about updates in contents cached in the adjacent base stations, and update the cache index tables of the adjacent base stations stored in the base station. The information about updates in cached contents may include: an identification of added contents and an identification of a base station, and/or an identification of deleted contents and an identification of the base station.

According to the above method, in response to a determination that the service data provided to the UE is from the cache of the base station, the base station may report accounting information to the SGW. The accounting information may include at least one of: a user identity, a bearer identity, time and the amount of traffic of the user. The accounting information may be reported through at least the following manners.

1) Control Plane Signaling

The S1-MME signaling may be enhanced or new signaling may be added to enable the base station to report the accounting information to a mobility management entity (MME).

A bearer context information element (IE) in a modify bearer command for S11 interface may be enhanced to enable, the MME to report the accounting information to the SGW. The SGW generates a telephone bill based on the accounting information.

2) User Plane Messages

A GTP-U report message is added for the S1-U interface to carry the accounting information to be reported by the base station to the SGW. The SGW generates a telephone bill based on the accounting information.

Various examples also provide a method of caching service data in LTE networks. The method may include:

parsing, by a SGW, a data request of a UE forwarded by a base station to obtain an identification of requested contents;

determining, by the SGW, whether the requested contents are cached in the SGW by using the identification, sending the requested contents to the base station in response to a determination that the requested contents are cached in the SGW.

The SGW may forward the data request to a PGW in response to a determination that the requested contents are not cached in the SGW, and returning contents obtained from the PGW to the base station.

In an example, the SGW may store a local cache index table to manage service data cached in the SGW. The local cache index table may include: an identification of contents, a start address of the contents in the local cache, and a length of the contents in the cache or an end address of the contents in the cache. The procedure of the SGW judging whether the requested contents are cached in the SGW may include: the SGW searches the local cache index table for the identification of the contents, determining the requested contents are cached in the SGW in response to a determination that the identification of the contents is found in the local cache index table, or determining the requested contents are not cached in the SGW in response to a determination that the identification of the contents is not found in the local cache index table.

In an example, the method may also include: after obtaining the contents from the PGW, the SGW caches the contents in the SGW, and adds a record of the contents in the local cache index table stored in the SGW.

The base station and/or the SGW has DPI capabilities, i.e., can parse contents of IP packets and extract information such as identifications of contents requested by users or the like.

### Example 1

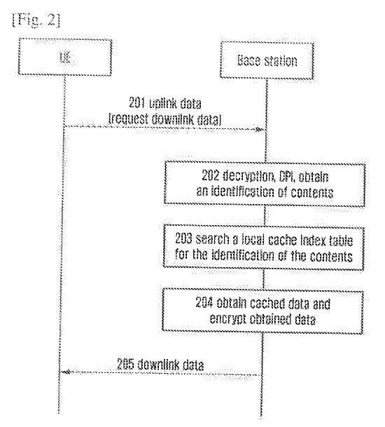

This example illustrates a process of obtaining service data cached in a base station. As shown in FIG. 2, the process may include the following procedures.

At block 201, after a bearer is established, a LIE sends a data request which includes an identification of contents (e.g., a URI) to a base station via an LTE-Uu interface.

At block 202, the base station decrypts received user data using a security algorithm, and performs DPI to obtain URI requested by a user.

At block 203, the base station searches a local cache index table and finds the URI.

At block 204, the base station obtains cached data using a start address and a length of the cached contents specified by a table entry that includes the URI, and encrypts the data using a security algorithm.

At block 205, the base station sends the data requested by the UE to the UE via the LTE-Uu interface.

### Example 2

This example illustrates a process of base stations obtaining and updating cached service data and updating a cache index table. As shown in FIG. 3, the process may include the following procedures.

At block 301, after a bearer is established, a UE sends a data request which includes an identification of contents (e.g., a URI) to base station 1 via an LTE-Uu interface.

At block 302, base station 1 decrypts received user data using a security algorithm, and performs DPI to obtain the URI requested by a user.

At block 303, base station 1 searches a local cache index table and fails to find the URI, searches cache index tables of adjacent base stations stored in base station 1 and finds the URI in the cache index table of base station 2 (if the URI is found in cache index tables corresponding to multiple eNodeB IDs, an arbitrary eNodeB ID may be selected).

At block 304, base station 1 sends an enhanced X2 interface message, e.g., a base station configuration update message (ENB_CONFIGURATION_UPDATE) which includes the URI and information of a GTP tunnel endpoint of base station 1 to establish a GTP tunnel between base station 1 and base station 2.

Table 1 shows information elements (IE) in ENB_CONFIGURATION_UPDATE. In this procedure, base station 1 may load the URI and information of a GTP tunnel endpoint of base station 1 (e.g., a transport layer address and a tunnel ID) in the Cache Context Information IE to establish the GTP tunnel between base station 1 and adjacent base station 2.

TABLE 1
X2AP message: ENB CONFIGURATION UPDATE
Direction: eNB₁ → eNB₂

| | | | IE type and | Semantics | | Assigned |
|---|---|---|---|---|---|---|
| IE/Group Name | Presence | Range | reference | description | Criticality | Criticality |
| <existing IEs> | | | | | | |
| Cache Context Information | | | | | — | — |
| > URI | O | | OCTET | | — | — |
| | | | STRING | | | |
| > GTP Tunnel Endpoint | O | | GTP Tunnel | eNB1 endpoint for | — | — |
| | | | Endpoint | receivingcache | | |
| | | | 36.423(9.2.1) | data. | | |
| CacheIndexList To Add | | 0 . . . <maxValue> | | | — | — |
| > URI | O | | OCTET | Add | — | — |
| | | | STRING | <eNB1.URI> to | | |
| | | | | CacheIndexList | | |
| CacheIndexList to Delete | | 0 . . . <maxValue> | | | — | — |
| > URI | O | | OCTET | Delete | — | — |
| | | | STRING | <eNB1.URI> from | | |
| | | | | CacheIndexList | | |

At block 305, base station 2 returns a base station configuration update response (e.g., an ENB_CONFIGURATION_UPDATE_ACKNOWLEDGE) to base station 1.

At block 306, base station 2 searches a local cache index table in base station 2 for the URI in the Cache Context Information IE in the base station configuration update message (ENB_CONFIGURATION_UPDATE), and in response to a determination that the URI is found, obtains the cached data according to a start address and a length of the cached contents specified in the table entry found in the local cache index table.

At block 307, base station 2 sends the obtained data to base station 1 via the established GTP tunnel, and sends an end marker packet to base station 1 indicating transmission of the cached data is completed.

At block 308, base station 1 caches the received data in base station 1, updates information in the local cache index table, e.g., the URI, a start address and a length of the cached contents, etc., and encrypts the data using a security algorithm.

At block 309, base station 1 sends the data requested by the UE to the UE via the LTE-Uu interface.

When data cached in base station 1 is subject to a change, a process may be executed to update information in cache index tables in all of adjacent base stations. The process may include the following procedures.

At block 310, base station 1 sends an enhanced X2 interface message, e.g., a base station configuration update message (ENB_CONFIGURATION_UPDATE) to all of adjacent base stations. The CacheIndexList To Add IE or the CacheIndexList to Delete IE as shown in Table 1 may include a URI list of added or deleted contents cached in base station 1.

At block 311, an adjacent base station adds or deletes information to update information in the cache index table of base station 1 stored in the adjacent base station according to the received information.

At block 312, the adjacent base station completes the update, and returns an ENB_CONFIGURATION_UPDATE_ACKNOWLEDGEM message to base station 1.

### Example 3

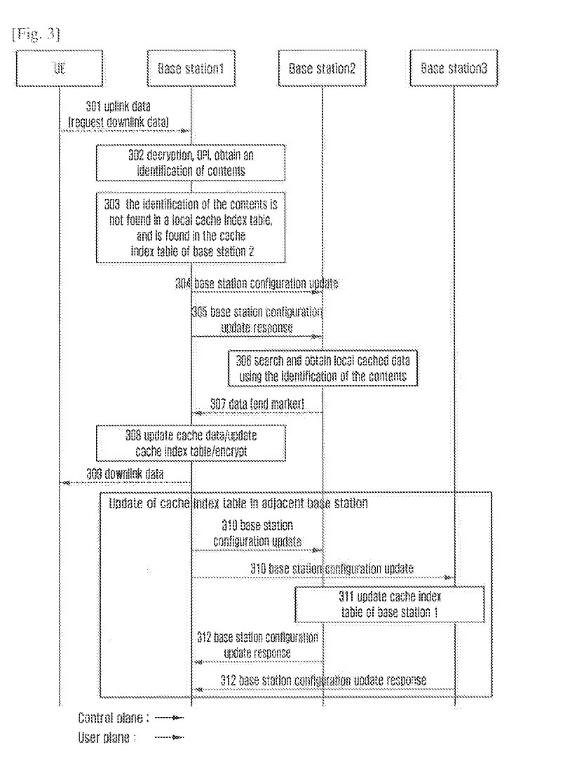

This example illustrates a process of obtaining and updating service data cached in an SGW and updating a cache index table. As shown in FIG. 4, the process may include the following procedures.

At block 401, after a bearer is established, a UE sends a data request which includes an identification of contents (e.g., a URI) to a base station via an LTE-Uu interface.

At block 402, the base station decrypts received user data using a security algorithm, and performs DPI to obtain the URI requested by a user.

At block 403, the base station searches a local cache index table and cache index tables of adjacent base stations for the URI, and fails to find the URI.

At block 404, the base station forwards the data request of the UE to an SGW via an S1-U interface to obtain data.

In response to a determination that the SGW is capable of caching data and stores a cache index table, the procedure in block 405 is performed. In response to a determination that the SGW is incapable of caching data and does not have a cache index table, the procedure in block 405c is performed.

At block 405, the SGW applies DPI to received data request to obtain the URI of the requested contents.

At block 406, the SGW searches a cache index table stored in the SGW for the URI, performs procedure in block 407a in response to a determination that the URI is found in the cache index table, or performs the procedure in block 407b in response to a determination that the URI is not found in the cache index table.

At block 407a, the SGW obtains the cached data using a start address and a length of the cached contents specified in a table entry found in the cache index table, and performs the procedure in block 409.

At block 407b, the SGW sends the data request to a PGW which requests data from a business server in an operator IP service network.

At block 408b, the SGW receives downlink data forwarded by the PGW from the business server, caches the data in the SGW, and updates information in the cache index table using a start address, a length and a URI of the cached contents, and performs the procedure in block 409.

At block 405c, the SGW sends the data request to the PGW which obtains data from a business server of an operator IP service network.

At block 409, the SGW sends the service data to the base station via an S1-U interface.

At block 410, the base station caches the received data in the base station, updates information in the local cache index table using the URI, a start address and a length of the cached contents, etc., and encrypts the data using a security algorithm.

At block 411, the base station sends the data requested by the UE to the UE via the LTE-Uu interface.

At block 412, a process is executed to update cache index tables in adjacent base stations, such as the procedures in blocks 310 to 312 as shown in FIG. 3.

At block 413, the SGW performs accounting using information such as a user identity, the amount of traffic and time of the traffic and the like.

Various examples also provide a base station corresponding to the above method. The base station is as shown in FIG. 5, and may include a first module, a second module and a cache module.

The cache module is configured to cache data;

the first module is configured to parse a data request received from a UE to obtain an identification of contents requested by the UE; and

the second module is configured to judge whether the requested contents are cached in the cache module by using the identification of the contents, and return the contents to the UE in response to a determination that the requested contents are cached in the cache module.

In response to a determination that the requested contents are not cached in the base station, an example may include: the second module judges whether the requested contents are cached in an adjacent base station, obtains the contents from the adjacent base station in response to a determination that the requested contents are cached in the adjacent base station, and returns the contents obtained from the adjacent base station to the UE; forwards the data request of the UE to an SGW in response to a determination that the requested contents are not cached in adjacent base stations, and returns the contents obtained from the SGW to the UE. The adjacent base station may include: another base station connected with the base station via an X2 interface.

In an example, the second module may send the identification of the contents and information of a GTP tunnel endpoint of the base station in an ENB_CONFIGURATION_UPDATE to establish a GTP tunnel between the base station and the adjacent base station, and receives the contents from the adjacent base station via the GTP tunnel.

In response to a determination that the requested contents are not stored in the base station, another example may include: the second module forwards the data request of the UE to an SGW, and returns contents obtained from the SGW to the UE.

In an example, the base station may also include a reporting module configured to report accounting information to the SGW. The accounting information may include at least one of: a user identity, a bearer identity, time of the traffic, and the amount of traffic.

In an example, the cache module is also configured to store a local cache index table. The local cache index table may include: an identification of contents, a start address and a length of the contents in the cache. The second module may searches the local cache index table for the identification of the requested contents to judge whether the requested contents are cached in the base station, and make a determination that the requested contents are cached in the base station in response to a determination that the identification of the requested contents is found in the local cache index table, or make a determination that the requested contents are not cached in the base station in response to a determination that the identification of the requested contents is not found in the local cache index table.

In an example, the cache module may also store a cache index table of an adjacent base station. The cache index table of the adjacent base station may include: an identification of contents and an identification of the adjacent base station. The second module may search the cache index table of the adjacent base station stored in the base station for the identification of the requested contents to judge whether the requested contents are cached in the adjacent base station, determining the requested contents are cached in the adjacent base station in response to a determination that the identification of the requested contents is found in the cache index table, or determining the requested contents are not cached in the adjacent base station in response to a determination that the identification of the requested contents is not found in the cache index table.

In an example, the second module may also cache the contents obtained from the adjacent base station or the SGW in the cache module, and add a record in the local cache index table stored in the cache module, and inform the adjacent base station of records of addition and/or deletion via an ENB_CONFIGURATION_UPDATE.

In an example, the second module may obtain information about an update of contents cached in the adjacent base station from a received ENB_CONFIGURATION_UPDATE, and update the cache index table of the adjacent base station stored in the base station. The information about an update of contents cached in the adjacent base station may include: an identification of newly added contents and an identification of the adjacent base station, and/or an identification of deleted contents and an identification of the adjacent base station.

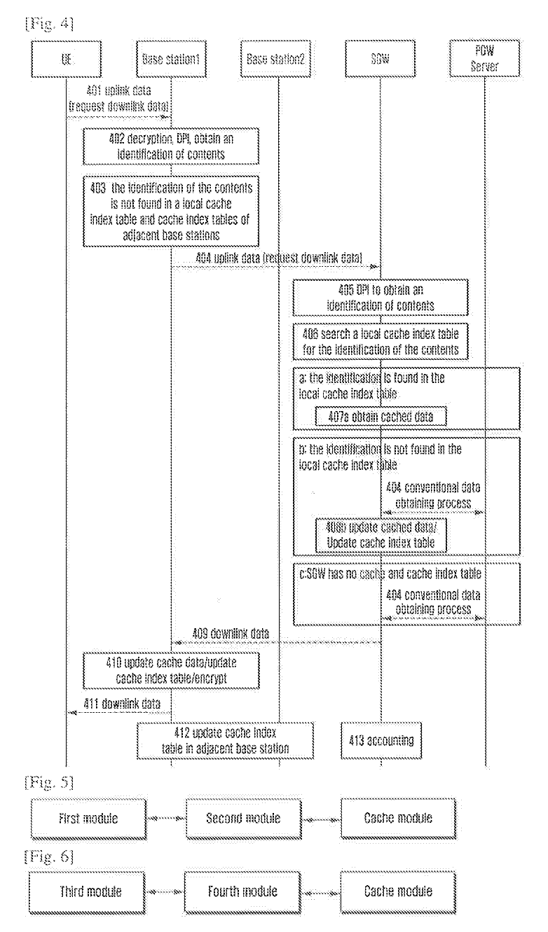

Various examples also provide an SGW corresponding to the above method. The base station is as shown in FIG. 6, and may include a third module, a fourth module and a cache module.

The cache module is configured to cache data:

the third module is configured to parse a data request received from a base station to obtain an identification of requested contents; and

the fourth module is configured to judge whether the requested contents are cached in the cache module by using the identification of the contents, and return the contents to the base station in response to a determination that the requested contents are cached in the cache module.

In an example, the fourth module may forward the data request to a PGW in response to a determination that the requested contents are not cached in the SGW, and return contents obtained from the PGW to the base station.

In an example, the cache module may also store a local cache index table. The local cache index table may include: an identification of contents, a start address and a length of the contents in the cache. The fourth module may search the local cache index table for the identification of the requested contents to judge whether the requested contents are cached in the SGW, and make a determination that the requested contents are cached in the SGW in response to a determination that the identification of the requested contents is found in the local cache index table, or make a determination that the requested contents are not cached in the SGW in response to a determination that the identification of the requested contents is not found in the local cache index table.

In an example, the fourth module may also cache the contents in the cache module after obtaining the contents from the PGW, and add a record of the contents in the local cache index table stored in the SGW.

The foregoing are only preferred examples of the present disclosure and are not for use in limiting the protection scope thereof. All modifications, equivalent replacements or improvements in accordance with the spirit and principles of the present disclosure shall be included in the protection scope of the present disclosure.

1. A method of caching service data in LTE networks, comprising:
parsing, by a base station, a data request received from a UE to obtain an identification of contents requested by the UE;
determining, by the base station, whether the requested contents are cached in the base station by using the identification, and sending the requested contents to the UE the requested contents are cached in the base station.

2. The method of claim 1, further comprising:
judging, by the base station, whether the requested contents are cached in an adjacent base station in response to a determination that the requested contents are not cached in the base station;
obtaining, by the base station, the requested contents from the adjacent base station in response to a determination that the requested contents are cached in the adjacent base station, and sending contents obtained from the adjacent base station to the UE; forwarding, by the base station, the data request from the UE to an SGW in response to a determination that the requested contents are not cached in the adjacent base station, and sending contents obtained from the SGW to the UE;
wherein the adjacent base station comprises: a second base station connected with the base station via an X2 interface.

3. The method of claim 2, wherein
the obtaining the contents from the adjacent base station comprises:
sending, by the base station, an identification of the contents and information of a GTP tunnel endpoint of the base station to the adjacent base station to establish a GTP tunnel between the base station and the adjacent base station, and receiving the contents from the adjacent base station via the GTP tunnel.

4. The method of claim 1, further comprising:
forwarding, by the base station, the data request of the UE to an SGW in response to a determination that the requested contents are not cached in the base station, and sending contents obtained from the SGW to the UE.

5. The method of claim 1, further comprising:
reporting, by the base station, accounting information to the SGW, wherein the accounting information comprises at least one of: a user identity, a bearer identity, time and the amount of traffic.

6. The method of claim 2, further comprising:
storing, by the base station, a local cache index table which comprises:
an identification of contents together with a start address and a length of the contents in a cache, or an identification of contents together with a start address and an end address of the contents in the cache;
wherein the judging by the base station whether the requested contents are cached in the base station by using the identification comprises:
searching, by the base station, the local cache index table for the identification of the requested contents, determining the requested contents are cached in the base station if the identification of the requested contents is found in the local cache index table, or determining the requested contents are not cached in the base station if the identification of the requested contents is not found in the local cache index table.

7. The method of claim 2, further comprising:
storing, by the base station, a cache index list of an adjacent base station which comprises: an identification of contents and an identification of the adjacent base station;
wherein the judging by the base station whether the requested contents are cached in an adjacent base station comprises: searching, by the base station, the cache index table of the adjacent base station for the identification of the requested contents, determining the requested contents are cached in the adjacent base station if the identification of the requested contents is found in the cache index table of the adjacent base station, or determining the requested contents are not cached in the adjacent base station if the identification of the requested contents is not found in the cache index table of the adjacent base station.

8. The method of claim 6, further comprising:
caching, by the base station, the obtained contents in the base station, adding a record in the local cache index table stored in the base station, and informing the adjacent base station of at least one record added and/or deleted by the base station.

9. The method of claim 7, further comprising:
obtaining, by the base station, information about an update of contents cached in the adjacent base station, and updating the cache index table of the adjacent base station stored in the base station; wherein the information about an update of contents cached in the adjacent base station comprises: an identification of newly added contents and an identification of the adjacent base station, and/or an identification of deleted contents and an identification of the adjacent base station.

10. The method of claim 1, wherein the identification of the contents is a uniform resource identifier (URI).

11. A base station, comprising: a first module, a second module, and a cache module; wherein
the cache module is configured to cache data;
the first module is configured to parse a data request received from a UE to obtain an identification of contents requested by the UE; and
the second module is configured to judge whether the requested contents are cached in the cache module by using the identification of the contents, and return the contents to the UE in response to a determination that the requested contents are cached in the cache module.

12. A method of caching service data in LTE networks, comprising:
parsing, by a SGW, a data request of a UE forwarded by a base station to obtain an identification of requested contents;
judging, by the SGW, whether the requested contents are cached in the SGW by using the identification, sending the requested contents to the base station in response to a determination that the requested contents are cached in the SGW.

13. The method of claim 12, further comprising:
forwarding, by the SGW, the data request to a PGW in response to a determination that the requested contents are not cached in the SGW, and returning contents obtained from the PGW to the base station.

14. The method of claim 12, further comprising:
storing, by the SGW, a local cache index table which comprises: an identification of contents together with a start address and a length of the contents in a cache, or an identification of contents together with a start address and an end address of the contents in the cache; and
caching, by the SGW, the contents obtained from the PGW in the SGW, and adding a record of the contents in the local cache index table stored in the SGW;
wherein the procedure of determining by the SGW whether the requested contents are cached in the SGW by using the identification comprises: searching, by the SGW, the local cache index table for the identification of the requested contents, determining the requested contents are cached in the base station if the identification of the requested contents is found in the local cache index table, or determining the requested contents are not cached in the SGW if the identification of the requested contents is not found in the local cache index table.

15. An SGW, comprising: a third module, a fourth module, and a cache module; wherein
the cache module is configured to cache data;
the third module is configured to parse a data request of a UE forwarded by a base station to obtain an identification of requested contents; and
the fourth module is configured to judge whether the requested contents are cached in the cache module by using the identification of the contents, and return the contents to the base station if the requested contents are cached in the cache module.
